(19) United States
(12) Patent Application Publication
(10) Pub. No.: US 2016/0141585 A1
(43) Pub. Date: May 19, 2016

(54) ELECTRICAL CONNECTOR FOR A BATTERY MODULE

(71) Applicant: ROBERT BOSCH GMBH, Stuttgart (DE)

(72) Inventors: Philipp Berg, Lennestadt (DE); Andreas Ruehle, Bietigheim-Bissingen (DE); Rene Deponte, Sersheim (DE); Ralf Angerbauer, Moeglingen (DE)

(21) Appl. No.: 14/904,235

(22) PCT Filed: Jun. 24, 2014
(86) PCT No.: PCT/EP2014/063202

§ 371 Date: Jan. 11, 2016

(30) Foreign Application Priority Data
Jul. 10, 2013 (DE) 10 2013 213 524.6

(51) Int. Cl. H01M 2/20; H01M 10/0525; H01M 10/48

(52) U.S. Cl. CPC H01M 2/206; H01M 10/48; H01M 10/486; H01M 10/0525; H01M 2220/20

(57) ABSTRACT

A battery module having at least two cells, wherein the at least two cells comprise electrical cell contacts, wherein the cell contacts are electrically connected to each other by at least one cell connector, wherein the battery module comprises a cell monitoring unit, wherein the cell monitoring unit is electrically connected to a connecting means, and wherein at least one cell contact and/or a cell connector are electrically connected via at least one bonding wire and/or at least one bonding strip to the connecting means.

### BACKGROUND OF THE INVENTION

The invention relates to an electrical connector for a battery module.

Electrical connectors are known from the prior art which electrically connect at least one battery cell of a battery module to a detection unit, for example by means of welding electrically conductive wires to the battery cell and the detection unit.

It is a disadvantage of the prior art that various manufacturing steps are required for producing and installing an electrically conductive connection between a battery cell and a detection unit. Thus, an electrical connector is manufactured, for example, from electrically conductive wires, wherein the wires must have an exact length and a curvature. Each electrical connector is welded or adhesively bonded to at least one battery cell and one detection unit. The electrically conductive wires are subsequently collected together to form a wiring harness.

### SUMMARY OF THE INVENTION

The method according to the invention has in contrast the advantage that the electrically conductive connection comprises at least one bonding wire and/or one bonding strip in order to produce an electrically conductive connection between at least one battery cell and a connecting means.

Aluminum, aluminum-silicon, copper or gold are advantageously used as the material for the bonding wire and/or the bonding strip in order to reduce conduction losses.

When using a bonding strip, it is an advantage that less damage occurs to the contacting surfaces, such as, for example, cracks on the contacting surfaces resulting from the bonding wire being to greatly bent. It is therefore possible to bridge the same distance with a bonding strip that is shorter in comparison to a bonding wire.

In the case of an electrically conductive connection which comprises more than one bonding wire and/or more than one bonding strip, contacting surfaces of the bonding wires and/or the bonding strips are advantageously disposed adjacently on a cell contact of the battery cell or, respectively, on the connecting means and/or on top of one another on the cell contact of the battery cell or on the connecting means.

The connecting means advantageously comprises a conductor plate, at least one conductor path and/or a plug, whereby a smaller installation space is required.

In order to produce an electrically conductive connection between the bonding wire and/or the bonding strip and a cell contact of the battery cell or, respectively, the connecting means, various attachment techniques are used, such as thermocompression bonding (TC bonding), thermosonic ball-wedge bonding (TS bonding) and/or an ultrasonic wedge-wedge bonding (US bonding).

These techniques are selected, for example, on the basis of a material of the bonding wires or the bonding strip used. Hence, the TC bonding is seldom used for bonding wires because this technique can lead to damage to the connecting elements due to the high forces and temperatures required to produce the connection, whereas the technique is however suited to a bonding of bonding strips. If gold or copper is used as the material for the bonding wires or bonding strips, the TS bonding is then a very suitable technique. If, on the other hand, aluminum or aluminum-silicon is used as the material for the bonding wires or bonding strips, the US bonding is advantageously used as the attachment technique.

A disposal of the battery cells that is optimized to the installation space is advantageously possible due to the smaller space requirement of the bonding wires and/or the bonding strips in comparison to the wiring harnesses used to date.

A new geometry and/or a new configuration of battery cells due to the mechanical flexibility of the bonding wires and/or the bonding strips as electrical connectors is advantageously possible. New geometries can advantageously be implemented using the bonding wires and/or bonding strips with a small amount of modification to the bonding machines.

By the use of the bonding wires and/or bonding strips, a production-related height difference, which results in an optimal cooling for an arrangement of battery cells at the bottom of the battery module, is advantageously compensated.

Weight is advantageously saved by each bonding wire and/or bonding strip due to a reduced material requirement in comparison to conventional wires, whereby a range of a vehicle is extended.

A heat transmission advantageously takes place by means of the bonding wires and/or the bonding strips; thus enabling at least one temperature sensor integrated into the connecting means or a temperature sensor disposed on the connecting means to detect a temperature of at least one battery cell by means of the bonding wires and/or bonding strips and to transmit the temperature to a cell monitoring unit. As a result, a sensor on the cell connector and/or in the cell monitoring unit is saved.

A sensor disposed on the connecting means is advantageously electrically contacted to said connecting means by means of at least one bonding wire and/or at least one bonding strip.

When comparing an application of bonding wires and/or bonding strips with an application of cell connectors according to the prior art, a repair of defective electrical connections between the cell contact and the connecting means is advantageously possible with comparatively low cost and effort. In order to repair a defective electrical connection, at least one new bonding wire and/or a new bonding strip is electrically contacted by means of bonding to a cell contact and to the connecting means, wherein contacting surfaces on the cell contact and the connecting means are advantageously sufficiently present due to the smaller cross sections of the bonding wires and/or bonding strips.

In an advantageous manner, a failure probability dependent on electrical and mechanical influences is reduced by a contacting of redundant bonding wires and/or bonding strips, for example by means of at least one further bonding strip between the cell contact and the connecting means.

In an advantageous manner, fewer manufacturing steps for contacting battery cells and the connecting means are required as a result of the bonding wires and/or bonding strips, whereby a reduced technical outlay for a manufacturing process of battery modules is required and a higher degree of automation is facilitated.

The battery module is advantageously used in a lithium-ion battery.

### BRIEF DESCRIPTION OF THE DRAWINGS

Exemplary embodiments of the invention are depicted in the drawings and explained in detail in the following description.

In the drawings:

FIG. 1 shows a battery module according to the prior art; and

FIG. 2 shows a battery module according to the invention.

### DETAILED DESCRIPTION

Identical reference signs denote identical components of the device in all of the figures of the drawings.

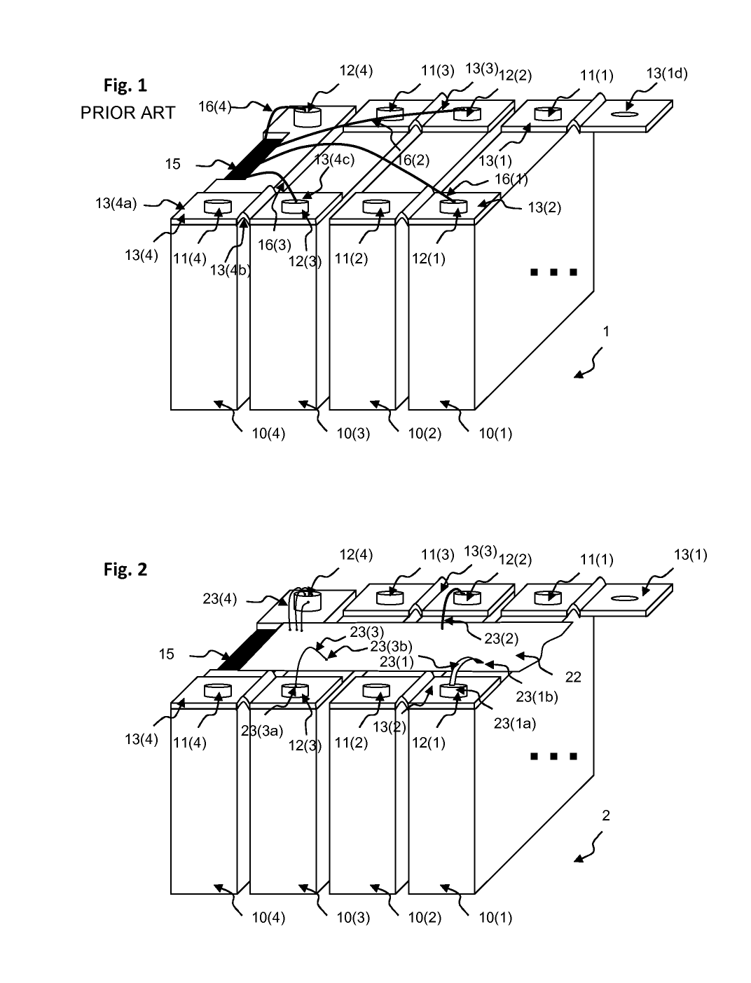

FIG. 1 shows four battery cells 10(1), 10(2), 10(3), 10(4) of a battery module 1 comprising cell contacts 11(1), 11(2), 11(3), 11(4), 12(1), 12(2), 12(3), 12(4) which are electrically connected to each other by electrical cell connectors 13(1), 13(2), 13(3), 13(4) so that a series circuit of the battery cells 10(1), 10(2), 10(3), 10(4) is formed in accordance with an embodiment according to the prior art. For example, the plus pole of the battery cell 10(1) is connected by means of the cell contact 12(1) via the electrical cell connector 13(2) to the minus pole of the battery cell 10(2) by means of the cell contact 11 (2).

The electrical cell connector 13(4) comprises a first connecting element 13(4a), a second connecting element 13(4c), as well as a curved connecting element 13(4b) which electrically connects the first connecting element 13(4a) to the second connecting element 13(4c). In order to establish an electrically conductive connection and mechanical connection between the cell contact 11(1) and the cell contact of a further battery cell by means of the cell connector 13(1), the cell connector 13(1) has, for example, a recess 13(1d).

The electrical cell connector 13(4) can be manufactured from a single piece or can be assembled from various electrically conductive materials. Tolerances of the battery cells and independent movements of the cells can be compensated by the curved connecting element 13(4b).

The electrical cell connector 13(4) is welded, adhesively bonded or clamped to the battery cells 10(3), 10(4).

A cell monitoring unit 15 is connected to the cell contacts 12(1), 12(2), 12(3), 12(4) of the battery cells 10(1), 10(2), 10(3), 10(4) by means of electrical connectors 16(1), 16(2), 16(3), 16(4), for example electrically conductive wires.

FIG. 2 shows four battery cells 10(1), 10(2), 10(3), 10(4) of a battery module 2 according to an embodiment of the invention comprising cell contacts 12(1), 12(2), 12(3), 12(4) which are electrically connected by means of a bonding wire 23(2), 23(3), 23(4) and or at least one bonding strip 23(1) to a connecting means 22.

In an advantageous embodiment, the electrically conductive connection comprises a single bonding wire 23(3) comprising a first contacting surface 23(3a) on a first cell contact 12(3) and a second contacting surface 23(3b) on the connecting means 22.

In an alternative embodiment, the electrically conductive connection comprises at least two bonding wires 23(4).

In a further alternative embodiment, the electrically conductive connection comprises the bonding strip 23(1) comprising a first contacting surface 23(1a) on a first cell contact 12(1) and a second contacting surface 23(1b) on the connecting means 22.

In an alternative embodiment, the second contacting surface 23(3b) is disposed on a conductor path, wherein the conductor path is on or in the connecting means and is electrically connected to a cell monitoring unit 15.

An electrically conductive connection between the cell contact 11(1) and a cell contact of a further battery cell is established by means of the cell connector 13(1).

Aluminum, aluminum-silicon, copper or gold are used as the material for the at least one bonding wire and the at least one bonding strip.

In an advantageous manner, the diameter of the bonding wire is between 10 μm and 100 μm; thus enabling a current flow between 0.3 A and 0.5 A to be ensured without the bonding wire being damaged, for example as a result of the effect of heat.

The width of the bonding strip is advantageously between 30 μm and 500 μm and the height of the bonding strip between 10 μm and 200 μm. In so doing, three bonding wires having a diameter of 100 μm can be replaced by one bonding strip.

The length of the bonding wire and/or the bonding strip is advantageously between 10 mm and 50 mm in order to achieve a sufficient mechanical stability between two contacting surfaces 20(1a), 20(1b) or 21(a), 21(b).

The cell monitoring unit 15 measures voltages of individual battery cells by means of the electrically conductive connection between the cell contacts 12(1), 12(2), 12(3), 12(4), the connecting means 22 and the cell monitoring unit 15, for example with the use of a voltage sensor. In addition, the cell monitoring unit can comprise a current sensor, a temperature sensor and/or resistors, for example for carrying out a balancing procedure on the battery cells.

In an alternative embodiment, the electrical cell connectors 13(1), 13(2), 13(3), 13(4) comprise wires, bonding wires and/or bonding strips for an electrically conductive connection between the cell contacts 11(1), 11(2), 11(3), 11(4), 12(1), 12(2), 12(3), 12(4).

1. A battery module (2) having at least one cell (10(1), 10(2), 10(3), 10(4)), wherein the battery module (2) comprises a cell monitoring unit (15), the cell monitoring unit (15) being electrically connected to a connecting means (22), characterized in that one or more of at least one cell contact (11(1), 11(2), 11(3), 11(4), 12(1), 12(2), 12(3), 12(4)) and at least one cell connector (13(1), 13(2), 13(3), 13(4)) is electrically connected via one or more of at least one bonding wire (23(2), 23(3), 23(4)) and at least one bonding strip (23(1)) to the connecting means (22).

2. The battery module (2) according to claim 1, characterized in that aluminum, aluminum-silicon, copper or gold is the material for one or more of the bonding wire (23(2), 23(3), 23(4)) and the bonding strip (23(1)).

3. The battery module (2) according to claim 1, characterized in that the bonding wire (23(2), 23(3), 23(4)) has a diameter between 10 μm and 100 μm.

4. The battery module (2) according to claim 1 characterized in that the bonding strip (23(1)) has a rectangular form having a width between 30 μm and 500 μm and a height between 10 μm and 200 μm.

5. The battery module (2) according to claim 1, characterized in that the one or more of the at least one bonding wire (23(2), 23(3), 23(4)) and the at least one bonding strip (23(1)) has a length between 10 mm and 50 mm.

6. The battery module (2) according to claim 1, characterized in that the cell monitoring unit (15) comprises at least one of the following: a voltage sensor; a current sensor; a temperature sensor and resistors.

7. The battery module (2) according to claim 1, characterized in that contacting surfaces of at least one of bonding wires (23(4)) and bonding strips are disposed adjacently on the cell contacts (12(4)).

8. The battery module (2) according to claim 1, characterized in that the connecting means (22) comprises at least one of the following: a conductor plate, at least one conductor path and a plug.

9. A method for manufacturing an electrically conductive connection between one or more of at least one cell contact (11(1), 11(2), 11(3), 11(4), 12(1), 12(2), 12(3), 12(4)) and at least one cell connector (13(1), 13(2), 13(3), 13(4)) of a battery module (2) comprising a connecting means (22) according to claim 1, characterized in that the electrically conductive connection is produced by a contacting surface (23(1a), 23(3a)) between one or more of at least one bonding wire (23(2), 23(3), 23(4)) and at least one bonding strip (23(1)) and cell contacts (11(1), 11(2), 11(3), 11(4), 12(1), 12(2), 12(3), 12(4)) of the at least two cells (10(1), 10(2), 10(3), 10(4)) and by a contacting surface (23(1b), 23(3b)) between one or more of the bonding wire (23(2), 23(3), 23(4)) and the bonding strip (23(1)) and the connecting means (22) by means of one or more of the following: thermosonic ball-wedge bonding; ultrasonic wedge-wedge bonding and thermocompression bonding.

10. (canceled)

11. A lithium-ion battery comprising a battery module according to claim 1.

12. The battery module (2) according to claim 1, characterized in that contacting surfaces of at least one of bonding wires (23(4)) and bonding strips are disposed respectively on the connecting means (22), on top of one another on the cell contacts (12(4)), or both.

13. The battery module (2) according to claim 1, characterized in that contacting surfaces of at least one of bonding wires (23(4)) and bonding strips are disposed respectively on the connecting means (22) in the case of an electrically conductive connection which comprises more than one bonding wire (23(4)), more than one bonding strip, or both.
